(19) United States
(12) Patent Application Publication
(10) Pub. No.: US 2010/0017041 A1
(43) Pub. Date: Jan. 21, 2010

(54) POWER SUPPLY EQUIPMENT FOR FUEL DISPENSING NOZZLE

(75) Inventor: Galliano Bentivoglio, Bologna (IT)

Correspondence Address: TUTUNJIAN + BITETTO, P.C., 20 CROSSWAYS PARK NORTH, SUITE 210, WOODBURY, NY, 11797, US

(73) Assignee: NOZZLE ENG. S.r.l., Sarrono (IT)

(21) Appl. No.: 12/306,078

(22) PCT Filed: Jun. 20, 2007
(86) PCT No.: PCT/IB2007/052378

§ 371 Date: Aug. 11, 2009

(30) Foreign Application Priority Data
Jun. 21, 2006 (IT) MO2006A000202

(51) Int. Cl. G05D 11/00

(52) U.S. Cl. 700/283

(57) ABSTRACT

Power supply equipment for a fuels dispensing nozzle includes solenoid valves for dispensing fuel, a microprocessor for operating the solenoid valves and at least one supercapacitor or ultracapacitor for supplying power to the solenoid valves.

### TECHNICAL FIELD

The present invention relates to power supply equipment for a fuel dispensing nozzle, particularly for a nozzle for dispensing liquid or gaseous fuel such as petrol, gas oil, kerosene, liquefied petroleum gas (LPG), methane, natural gas, hydrogen, etc.

The power supply equipment according to the present invention is designed to provide a power supply for a fuel dispensing nozzle provided, for example, with a solenoid valve for dispensing fuel, or provided with other equivalent electrical means, such as electric motors, for dispensing fuel. More generally, the power supply equipment according to the present invention can be applied to an electrically operated device for dispensing hazardous and/or highly flammable liquids or gas.

### PRIOR ART

Known fuel dispensing nozzles generally have mechanically and manually operated dispensing valves, and therefore require no power supply.

U.S. Pat. No. 5,184,309 discloses an electrically operated fuel dispensing nozzle provided with a rechargeable battery as the electrical energy source for the operating and display circuits, and in particular for the power supply to the fuel flow control valve.

Rechargeable battery technology is widespread, tried and tested, and reasonably economical. Two different types of battery are used at present in the electronics field, namely nickel metal hydrate batteries, known by the abbreviation NiMh, and lithium ion batteries, known by the abbreviation LiIon. Nickel metal hydrate batteries are characterized by reasonable safety in operation and lower cost, but are relatively heavy and bulky; lithium ion batteries are smaller, lighter and more expensive, and their operation is also more critical.

Both types of battery have certain drawbacks in common, related mainly to the recharging circuit and shorter service life.

Recharging always requires particular attention, since it is necessary to meet a number of conflicting requirements, concerning the optimization of life between charges, the recharging rate and the risks of explosion associated with the overcharging of batteries, particular in respect of lithium ion batteries.

As regards the service life, it should be borne in mind that even the best batteries can be recharged for a maximum of a thousand times, after which they must be replaced. When rechargeable batteries are used in a fuel dispensing nozzle, there will be frequent recharges of a very partial nature, and therefore this application enables the number of recharges to be greatly increased, but it is difficult to achieve more than ten thousand recharges.

Battery life is further reduced by low ambient temperatures, such as the temperatures which may be present in mountainous regions in winter; no battery can be recharged at a temperature below −10° C.

These factors have some particularly negative consequences for a nozzle for dispensing fuel, hazardous and/or highly flammable liquids or gas.

The battery charger must provide special safety functions, to prevent overcharging of the batteries. If a battery is overcharged, there may be releases of gas or, ultimately, even explosions.

Provision must also be made for replacing the battery, by forming a suitable hatch in the body of the nozzle; this not only increases the cost of the nozzle but also gives rise to problems relating to the requirements of robustness and sealing of equipment for dispensing fuel, hazardous and/or highly flammable liquids or gas.

A stock of replacement batteries must also be provided and managed. The requirement for a store of replacement batteries is financially burdensome, especially as storage times for rechargeable batteries are limited and the batteries have a limited life.

It is also necessary to make the operators of fuel dispensers aware that a battery must not be replaced in an explosive atmosphere, and consequently the nozzle must be mechanically detached from the hose connected to the dispensing pump on each occasion.

A possible alternative to a power supply based on rechargeable batteries is the provision of a wired connection to the electrical mains.

However, this solution is difficult to implement, since it gives rise to considerable complications concerning installation. This is because the formation of a wired connection to the electrical mains requires power supply devices in the dispensing pump, electrical cables extending along the fuel hose to reach the dispensing nozzle, and electrical connection plugs and outlets to allow dismantling and the separation of the fuel hose from the pump and from the dispensing nozzle.

For the purpose of explosion-proofing, the wired connection to the electrical mains must have special safety arrangements which make the wired connection very costly and impractical to produce. The electrical connections along the fuel hose could also be subject to faults, bad contacts, interruptions, etc.

### DISCLOSURE OF THE INVENTION

One object of the present invention is therefore to improve the known power supply equipment for fuel dispensing nozzles.

Another object of the invention is to provide power supply equipment for a fuel dispensing nozzle which is reliable in operation for very long periods.

Yet another object of the invention is to provide power supply equipment for a fuel dispensing nozzle which is sealed and explosion-proof.

A further object of the invention is to provide power supply equipment for a fuel dispensing nozzle which is simple and economical to produce.

According to one aspect of the present invention, power supply equipment for a fuel dispensing nozzle as specified in claim 1 is described.

The invention makes it possible to supply power to a fuel dispensing nozzle in a safe and reliable way, without requiring expensive connecting wires to the electrical mains, and to achieve reliable operation which is practically unlimited in time.

The dependent claims relate to preferred and advantageous embodiments of the invention.

### BRIEF DESCRIPTION OF THE DRAWINGS

Other objects and advantages of the present invention will be made clearer by the following detailed description of some preferred embodiments of the present invention, provided with reference to the attached drawings, in which:

FIG. 1 is a schematic view of the electrical equipment of the power supply equipment for a fuel dispensing nozzle according to the present invention;

FIG. 2 is a schematic view of a detail of a version of the electrical equipment of the power supply equipment for a fuel dispensing nozzle according to the present invention; and

FIG. 3 is a block diagram of the modes of operation of the power supply equipment for a fuel dispensing nozzle according to the present invention.

### EMBODIMENTS OF THE INVENTION

With reference to the drawings, the number 1 indicates the whole of the electrical equipment for a fuel dispensing nozzle (which is not shown).

The nozzle comprises a main solenoid-operated cut-off valve 5 which can open and close a pipe (not shown) for dispensing liquid or gaseous fuel, such as petrol, gas oil, kerosene, liquefied petroleum gas (LPG), methane, natural gas, hydrogen, etc., and a secondary solenoid valve 6 for dispensing a small flow of fluid, this secondary solenoid valve 6 being usable for topping up the fuel or in case of failure of the main solenoid valve.

The electrical equipment 1 essentially comprises a microprocessor 2 and capacitor means 3.

The capacitor means 3 can comprise one or more supercapacitors 4. As is known, so-called supercapacitors, also called ultracapacitors, are capacitors with a very high electrical capacitance, generally above 0.1 farad, and small dimensions.

The capacitor means 3 supply power to the electrical components of the fuel dispensing nozzle, in other words, in particular, to the main solenoid 5, comprising an operating coil 17, the secondary solenoid valve 6, comprising an operating coil 18, and operation indicator LEDs 7 and 8.

In one version, the capacitor means 3 comprise two supercapacitors 4 having a capacity of 50 farads and 2.7 volts each, the two supercapacitors 4 being connected in series so as to provide a voltage of 5.4 volts.

The equipment 1 comprises electrical connection means 9 for connecting the nozzle electrically to the nozzle holder (not shown) which is located on the dispensing pump (not shown). The nozzle holder also comprises a power supply line for recharging the capacitor means 3. In one version, the electrical connection means 9 are made in the form of metal contacts.

The power supply line which runs from the electrical connection means 9 includes voltage limiter means 10, which prevent the capacitor means 3 from discharging violently if the electrical connection means 9 accidentally come into contact with an earth connection outside the nozzle. Such accidental contact could cause an electrical discharge, creating a risk of igniting any fuel vapour present in the area. In one version of the invention (not shown), the voltage limiter means 10 comprise two diodes 11, for example two Schottky diodes. As is known, Schottky diodes have a low potential absorption and a high switching speed, and are therefore particularly suitable for this type of application.

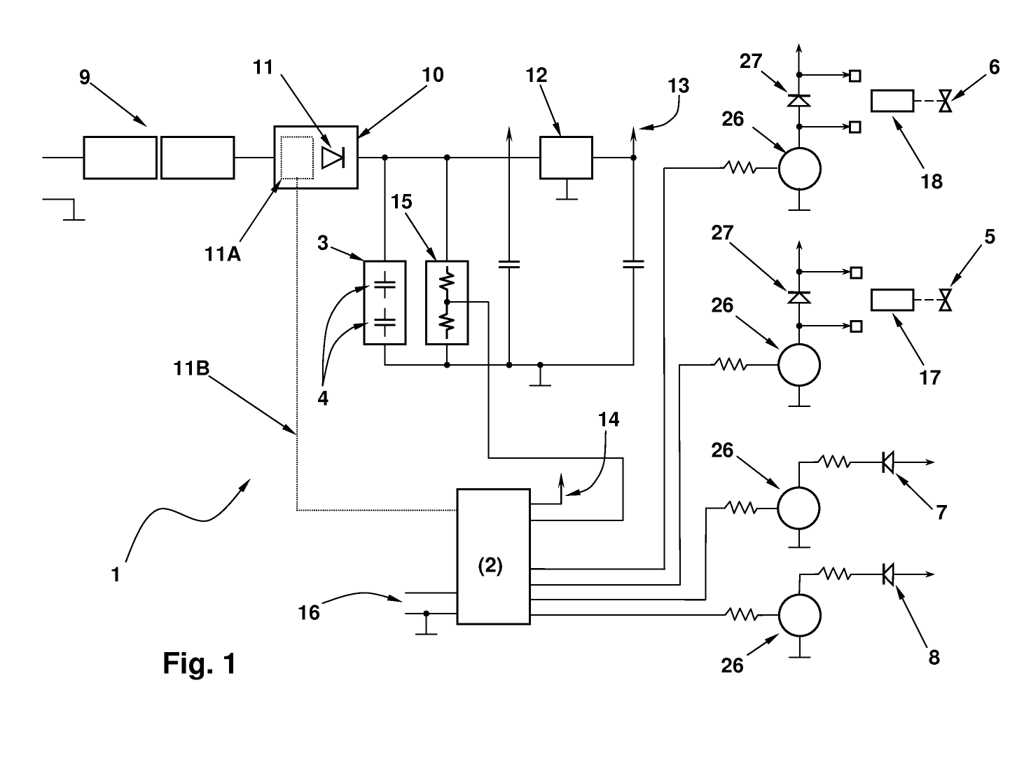

In yet another version, shown in FIG. 1, a voltage limiter device 11A is connected in the power supply line in place of one diode 11, for the purpose of preventing the overcharging of the supercapacitors in case of malfunctions of the recharging device; in this case, only one Schottky diode 11 is needed.

The microprocessor 2 is connected to the voltage limiter device 11A by means of a line 11B, in such a way that the incoming electrical voltage can be measured.

Additionally, since the supercapacitors could evolve gases if all the safety devices fail, creating an explosion hazard, said supercapacitors 4 and the shell (not shown) of the nozzle are both provided with notches which can open in a controlled way.

In another version, the electrical connection means 9 are formed by using bearings (not shown) made from conductive rubber, placed on the nozzle holder and on the nozzle.

Conductive rubber is a rubber which comprises a dispersion of material capable of conducting electric current, and has some beneficial features for use in fuel dispensing nozzles and in areas where fuel vapour may be present.

Because of its intrinsic characteristics, conductive rubber creates an electrical contact which is progressive and distributed over a certain surface area. Consequently, conductive rubber, unlike metal contacts, eliminates any possibility of sparks or electrical discharges at the instant when an electric contact is made.

Another beneficial feature of conductive rubber is the possibility of adaptation, because of the softness and yielding characteristics of rubber, allowing the tolerances between the contacts to be larger without causing problems in making the electrical connection.

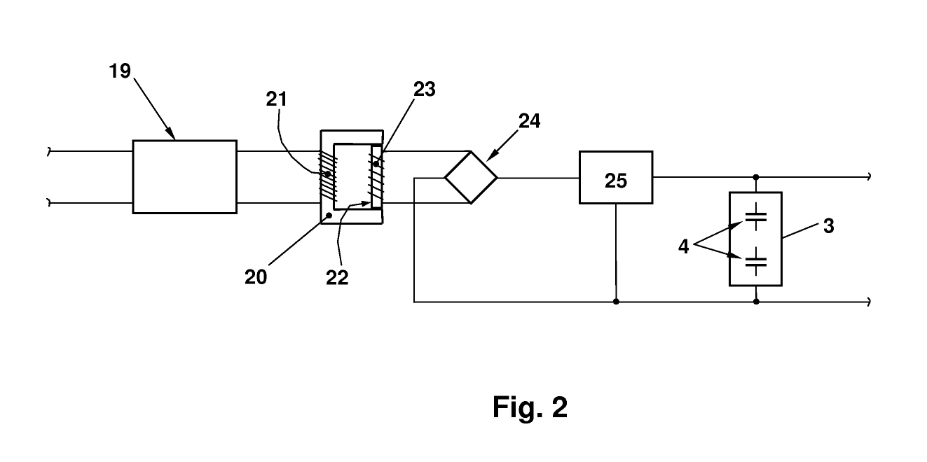

FIG. 2 shows a further version of the electrical connection means 9 between the nozzle and the nozzle holder.

In this version there is not a true electrical contact, because the electric current is transferred by electromagnetic induction means using a transformer which is made to be separable.

The nozzle holder has a power supply and oscillator unit 19 and an open C-shaped portion of a ring 20, which forms part of a voltage transformer having a primary winding 21. In the fuel dispensing nozzle there is a straight element 22, complementary to the portion of ring 20 and having a secondary winding 23, a rectifier bridge 24 and a charge controller 25.

The power supply and oscillator unit 19 modifies the frequency of the alternating current obtained from the mains. For example, starting with an alternating mains current with a frequency of 50 Hz and a voltage of 230 volts, the power supply and oscillator unit 19 converts the current to a frequency of 50-100 kHz with a voltage of 24 volts, because this voltage and frequency are more suitable than those of the mains current for transferring the current into the nozzle.

When the nozzle is positioned in the nozzle holder, the portion 20 and the element 22 form a ring of a transformer, and a current with a voltage of 5.0 volts, for example, is generated by electromagnetic induction in the secondary winding.

It should be noted that the portion 20 and the element 22 do not form a perfectly continuous ring of a transformer, since there are two interruptions which enable the nozzle to be separated from the nozzle holder.

These interruptions could cause dispersion of the magnetic field lines and thus provide only a low current transfer efficiency.

However, when the current has a high frequency, such as the frequency of 50 to 100 kHz indicated in the example, and given a suitable choice of materials for the portion 20 and the element 22, it is possible to eliminate or considerably limit this phenomenon of dispersion of the magnetic field lines and thus obtain a very high efficiency of transfer of the electric current between the nozzle holder and the nozzle.

Downstream of the electrical connection means 9, the equipment 1 comprises a voltage controller 12 and a voltage divider 15. The voltage divider 12 supplies a stabilized voltage through the contact 13, connected to a corresponding contact 14 on the microprocessor 2, to provide the power supply to the microprocessor 2. In one version of the invention, the voltage controller 12 supplies a stabilized voltage of 2.5 volts.

By means of the electrical divider 15, the microprocessor 2 detects the residual electrical charge of the capacitor means 3 and converts said residual electrical charge into a digital signal.

The microprocessor 2 also comprises a program or software which receives at its input the value of the voltage measured previously in the capacitor means 3, and which supplies at its output a duty cycle which modulates the amplitude of a pulse of the electric current flowing from the capacitor means 3.

This is because, in order to be able to use supercapacitors for supplying power to an electronic circuit, adaptations and modifications have to be made to the circuits supplied by rechargeable batteries.

In a rechargeable battery, the voltage across the terminals is kept practically constant until the battery is discharged, whereas in supercapacitors the voltage decreases with time as a function of the level of charge, in other words the electric current, which is actually supplied.

Electronic circuits are normally designed to be supplied with a practically constant voltage. Consequently, a problem arises when an electronic circuit is supplied by supercapacitors, owing to the progressive decrease in voltage caused by the progressive discharge of the supercapacitors. The problem of the progressive decrease of voltage is particularly significant in relation to the power supply to the coils 17 and 18 which operate the solenoid valves 5 and 6.

The coils 17 and 18 need a certain electric current to flow through them in order to create a sufficient magnetic field to move the internal armature which causes the opening of a passage for the fluid to be dispensed.

The movement of the armature can depend on the masses and forces present, for example those due to the internal resistance for opening the passage for the fluid, and to the force of any opposing springs.

Solenoid valves therefore have a degree of mechanical inertia in operation. Solenoid valves are substantially sensitive only to the mean value of the electric current supplied to the operating coils 17 and 18.

It is therefore possible to supply the coils 17 and 18 by a method known as PWM (Pulse Width Modulation), thus obtaining a force proportional to the mean value of the voltage, which in turn depends in a linear way on the peak value and duration of the duty cycle.

In other words, the coils 17 and 18 of the solenoid valves are supplied with power in a pulsed way, with time intervals of variable length. The pulsation frequency of the power supply can be predetermined or variable, with a value in Hz which is a function of the electromechanical characteristics of the coil.

Each coil 17, 18 is designed to have a very high value of the L/R ratio, in order to minimize the power losses in the coil. It should be borne in mind that the required power loss and consequently the life of the supercapacitors depends solely on the resistive component, which is therefore to be minimized, subject only to the practical limit of the dimensions of the coil, which depend on the cross section of the wire used.

When the voltage of the capacitor means 3 is high, the length of the pulses can be relatively small.

The capacitor means 3 discharge progressively, the peak voltage decreases with time, and it is therefore necessary and sufficient to increase the duty cycle proportionally, thus obtaining a constant mean value over the whole discharge period of the capacitor means 3.

This function is performed by the microprocessor 2 which also controls the operation of the whole nozzle; the microprocessor 2 reads the voltage of the capacitor means 3 and generates a PWM signal, or pulse width modulation signal, with an appropriate duty cycle.

Table 1 shows an example of the variation of the duty cycle, expressed as a percentage (Duty/255%), produced by the microprocessor 2 on the basis of the measurement of the voltage, expressed as a percentage (Voltage/63%), of the capacitor means 3.

TABLE 1

| Duty/255% | Voltage/63% |
|---|---|
| 240 | 20 |
| 229 | 21 |
| 219 | 22 |
| 209 | 23 |
| 201 | 24 |
| 192 | 25 |
| 186 | 26 |
| 178 | 27 |
| 172 | 28 |
| 166 | 29 |
| 167 | 30 |
| 155 | 31 |
| 151 | 32 |
| 146 | 33 |
| 142 | 34 |
| 138 | 35 |
| 134 | 36 |
| 130 | 37 |
| 127 | 38 |
| 124 | 39 |
| 120 | 40 |
| 118 | 41 |
| 115 | 42 |
| 112 | 43 |
| 109 | 44 |
| 107 | 45 |
| 105 | 46 |
| 103 | 47 |
| 100 | 48 |
| 98 | 49 |
| 96 | 50 |
| 94 | 51 |
| 93 | 52 |
| 91 | 53 |
| 89 | 54 |
| 88 | 55 |
| 86 | 56 |
| 85 | 57 |
| 83 | 58 |
| 82 | 59 |
| 80 | 60 |
| 79 | 61 |
| 78 | 62 |
| 76 | 63 |

It should be noted that there is no additional cost of hardware components for implementing this method, because the computing and control-capacity of the same microprocessor 2 is used, with the aid of a suitable program or software.

As stated previously, the microprocessor 2 is supplied with power through a voltage controller 12 which provides an electric current with a stabilized voltage. This current is used for recharging other independent capacitor means (not shown), comprising at least one supercapacitor, which have the sole purpose of supplying the microprocessor 2. The capacitor means for supplying the microprocessor 2 are controlled by the PWM, or pulse width modulation, method in the same way as the capacitor means 3, so that a constant voltage is also provided for the supply of the microprocessor 2. In another version of the invention, the microprocessor 2 is supplied directly by the capacitor means 3.

The microprocessor 2 has electrical connections for operating the solenoid valves 5 and 6, the operation indicator LEDs 7 and 8, and an electrical connection 16 for the operating command for dispensing the fuel.

MOSFET transistors 26 and recirculation diodes 27 are used according to a known method to operate the coils 17 and 18 of the solenoid valves 5 and 6. MOSFET transistors 26 are also provided for switching on the operation indicator LEDs 7 and 8.

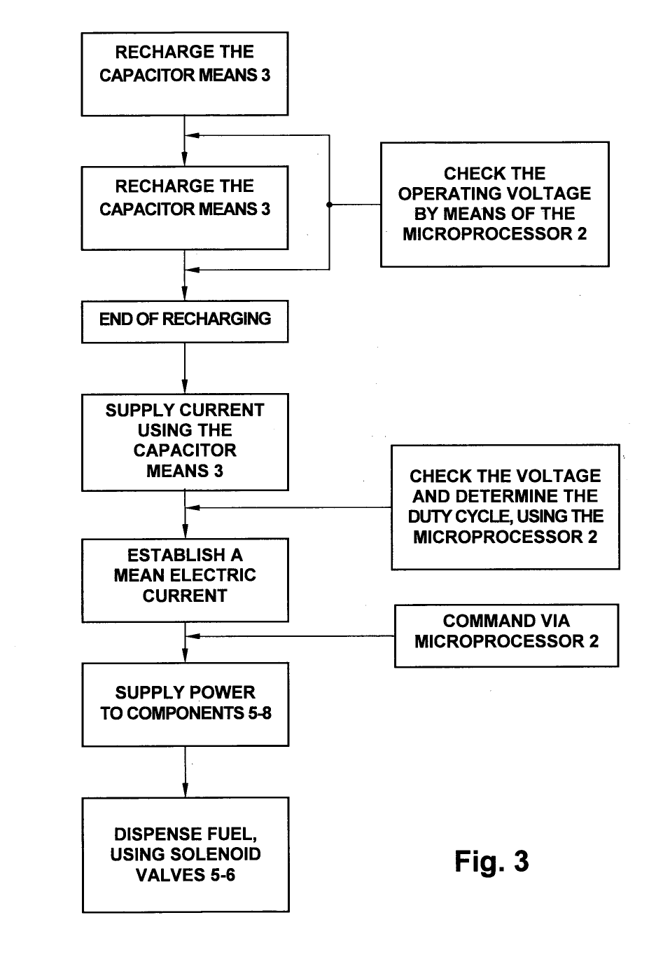

FIG. 3 shows a block diagram which summarizes the principal steps of the operation of the electrical equipment according to the invention.

Initially, the fuel dispensing nozzle is inserted in the nozzle holder on the pump and the capacitor means 3 are recharged through the connection means 9; the recharging circuit generates a constant current of about 0.5 A, with the maximum voltage limited to 9 volts for safety reasons.

The microprocessor 2 measures the voltage present in the capacitor means 3 during the recharging step. During recharging, the voltage of the capacitor means 3 increases progressively. This step is very brief and is interrupted by the voltage limiter 11A as soon as the maximum permitted voltage for the capacitor means 3 is reached.

When the nozzle is removed from the nozzle holder to start dispensing the fuel, the user operates the nozzle, and the capacitor means 3 start to supply the necessary electric current to operate the electrical components of the nozzle, namely the solenoid valves 5 and 6 and the operation indicator LEDs 7 and 8.

The microprocessor 2 continuously controls the voltage of the capacitor means 3, using the current divider 15, and detects the decrease in voltage which takes place progressively during the supply of current, in other words during the discharge of the capacitor means 3.

As a result of the decrease in voltage, the microprocessor 3 modifies the duty cycle, in the way indicated above, so as to maintain a constant mean voltage.

The microprocessor 3 then uses the aforesaid constant mean voltage to supply the solenoid valves 5 and 6 and the operation indicator LEDs 7 and 8, on the basis of the command provided by the user by means of the contacts 16.

The coils 17 and 18 of the solenoid valves, as well as the LEDs 7 and 8, must have a nominal operating voltage below that of the maximum charge of the capacitor means 3.

For example, if the coils 17 and 18 have an operating voltage of 1.5 volts, the capacitor means 3 must have a maximum charge voltage of 5 volts.

The coils 17 and 18 and the LEDs 7 and 8 therefore cease to operate when the residual voltage of the capacitor means 3, starting from the maximum charge voltage of 5 volts, falls below the value of 1.5 volts. This is because, if the voltage of the capacitor means 3 has fallen below the value of 1.5 volts, it is impossible to obtain a voltage of 1.5 volts by PWM, or pulse width modulation, control, and therefore it is impossible to operate the coils 17 and 18 and the LEDs 7 and 8. In this last-mentioned case, it is therefore necessary to recharge the capacitor means 3.

The duration of charge of the capacitor means 3, in other words the possibility of supplying electric current to the components of the nozzle, depends on the capacity of the capacitor means 3: an operating duration of the nozzle of at least 10 minutes can be achieved with the supercapacitors chosen for this application, and with the supercapacitors currently available on the market.

Supercapacitors having a greater capacity, permitting an even longer operating duration, are also available.

The operating duration of 10 minutes is clearly sufficient for dispensing a quantity of fuel for refueling a vehicle. However, the recharging of the capacitor means 3 requires a very short time, and therefore it is sufficient to insert the nozzle into the nozzle holder briefly in order to recommence fuel dispensing.

Another important feature of the power supply equipment of the fuel dispensing nozzle according to the invention is the possibility of heating the nozzle in the presence of very low ambient temperatures.

Fuel dispensing nozzles are normally installed at outdoor service stations, where the temperature can fall to a rather low level, especially in winter.

In normal continental climates, even at a low altitude, the night temperature in winter can fall to −20° C.; at higher latitudes, or at higher altitudes, the temperature can fall even lower.

This gives rise to severe constraints on the elastomeric sealing gaskets, which tend to stiffen, causing their operation to be seriously impaired.

Furthermore, since the materials having the best resistance to hydrocarbons tend to degrade rapidly in cold conditions, the gaskets are usually made from other materials which have a lower resistance to hydrocarbons but better behaviour at low temperature.

In addition to the technical problem of the stiffening of the gaskets, there is another problem relating to the practicality of use, namely the fact that grasping a fuel nozzle without gloves at a low temperature can cause the skin to adhere to the nozzle, because of the immediate freezing of the surface moisture.

To overcome this problem, the nozzle would have to be heated to bring it to a temperature of about zero degrees centigrade, or preferably a few degrees above, for example about 3-5 degrees centigrade above zero.

In order to heat the nozzle, it is necessary to use heating means, but these are rather difficult to provide in the case of a mechanical fuel nozzle, since no form of thermal energy, and possibly no other kind of energy, is available in a mechanical fuel nozzle.

In a nozzle which is electrically operated by means of power supply equipment according to the invention, it is possible to use electric heating means.

The electrically operated nozzle has connection means 9 which connect the nozzle electrically to the nozzle holder located on the fuel pump. This electrical connection has the purpose of supplying and recharging the internal devices in the way described above.

An unlimited power supply is therefore available to the nozzle while it is in the nozzle holder. An electric circuit can therefore provide thermostatically controlled heating of the nozzle throughout the period for which the nozzle is unused.

In a first version, the thermostatically controlled heating of the nozzle can be provided by means of a thermostatic device, which may be of a commercially available type, associated with electric heating means.

For example, the heating means comprise at least one electrical resistance with sufficient power to provide the aforementioned temperature range, in other words a temperature of a few degrees centigrade above zero.

In another version, the thermostatically controlled heating of the nozzle is provided by means of the microprocessor 2, which incorporates a temperature sensor and can therefore control electric heating means.

The temperature at which the device is set depends on the characteristics of the materials used: for gaskets made from Viton (a registered trademark of DuPont Dow), for use down to −10° C., a value of slightly above 0° C. is considered to be prudent.

In another version, the nozzle can be heated in another way which is particularly simple and economical.

With reference to the electrical diagram in FIG. 1, the microprocessor 2 also comprises an integrated temperature sensor (not shown), an input voltage measurement circuit and a drive circuit for the two solenoid valves 5 and 6.

The microprocessor 2 also comprises a program or software for the operation of the temperature sensor and the operating circuits of the solenoid valves 5 and 6.

The microprocessor 2 can also detect the operating state of the nozzle, in other words whether the nozzle has been returned to the nozzle holder or is in use during the dispensing of fuel. Using the voltage limiter device 11A and the measurement line 11B, the microprocessor detects whether or not there is an input voltage upstream of the voltage limiter device. If a voltage is present, the nozzle has been returned to the nozzle holder, because the capacitor means 3 are being charged; if no voltage is present, the nozzle is in use, in other words fuel is being dispensed. When the nozzle is in use, the operating mode of the microprocessor 2 is as described above.

When the nozzle is in the nozzle holder, the microprocessor 2 executes the following steps:

1) the microprocessor 2 periodically detects the temperature by means of the temperature sensor integrated into the microprocessor;

2) if the temperature of the nozzle is below a predetermined level—for example if the temperature is below two degrees centigrade—the microprocessor 2 activates the heating means as described more fully below;

3) if the temperature of the nozzle is above the desired level, the microprocessor 2 switches off the heating means;

4) the microprocessor 2 performs a further check to discover whether the nozzle is still in the nozzle holder;

5) if the nozzle is in the nozzle holder, the microprocessor 2 returns to step 1 and executes steps 1-4 again;

6) if the nozzle is not in the nozzle holder, the nozzle must be in use, and the microprocessor 2 controls the normal dispensing operation of the nozzle as described above.

The microprocessor 2 activates the heating means, as stated above in relation to step 2; the aforesaid heating means can comprise an electrical resistance or other electric heating means.

In another version of the present invention, the heating means comprise the coils 17 and 18 of the solenoid valves 5 and 6, supplied with power at a level which is too low to operate the solenoid valves.

Each coil requires a certain electrical power to switch the solenoid valve: for example, in one case, the power required for each coil 17, 18 is about 1 watt.

If the electrical power supplied to each coil 17, 18 is lower, for example less than 0.5 watt, whereas the aforesaid coils require at least 1 watt for operation, the magnetic field produced by each coil 17, 18 is insufficient to cause the opening movement of the solenoid valve.

However, the electrical power supplied, being about 1 watt in the present example, is dissipated in the coil of the solenoid valve and heats the nozzle by the Joule effect.

Thus, in order to produce heat inside the nozzle, the microprocessor supplies the two coils with a power below the level required to open the solenoid valves; the electrical power which is supplied is dissipated in heat by the Joule effect.

The insufficient supply to the coils 17 and 18 is provided by using the PWM, or pulse width modulation, control program already loaded into the microprocessor 2, to simply reduce the duration of the duty cycle by the required amount in order to decrease the electrical power drawn.

1-43. (canceled)

44. Power supply equipment (1) for a fuel dispensing nozzle comprising solenoid valves (5, 6) for dispensing fuel, a microprocessor (2) for operating the solenoid valves (5, 6), and capacitor means (3) for supplying power to at least said solenoid valves (5, 6).

45. Equipment according to claim 44, wherein said capacitor means (3) comprises at least one of a supercapacitor and an ultracapacitor (4).

46. Equipment according to claim 44, comprising electrical connection means (9) for connecting the capacitor means (3) electrically to a nozzle holder which is located on the dispensing pump, said nozzle holder comprising a power supply line for recharging the capacitor means (3).

47. Equipment according to claim 46, wherein the electrical connection means (9) comprises an electromagnetic induction means (19-25).

48. Equipment according to claim 47, comprising limiter means (10) connected in the power line for connecting the electrical connection means (9) electrically to the capacitor means (3).

49. Equipment according to claim 48, wherein said limiter means (10) comprises a limiter device (11A).

50. Equipment according to claim 49, wherein said limiter means (10) comprises one or two diodes (11).

51. Equipment according to claim 48, wherein said limiter means (10) comprises said microprocessor (2) which detects the residual voltage in the capacitor means (3).

52. Equipment according to claim 47, further comprising LED diodes (7, 8) for indicating the operation of the nozzle.

53. Power supply equipment (1) for a fuel dispensing nozzle comprising solenoid valves (5, 6) for dispensing fuel, a microprocessor (2) for operating the solenoid valves (5, 6), and capacitor means (3) for supplying power to at least said solenoid valves (5, 6), said microprocessor (2) comprising a program or software which receives at its input the value of the voltage of the capacitor means (3).

54. Equipment according to claim 53, wherein said capacitor means (3) comprises at least one of a supercapacitor and an ultracapacitor (4).

55. Equipment according to claim 54, wherein said solenoid valves (5, 6) comprise electromagnetic operating coils (17, 18).

56. Equipment according to claim 54, wherein said microprocessor (2) supplies at its output a duty cycle which modulates the amplitude of a current pulse produced from an electric current supplied by the capacitor means (3), using the method known as pulse width modulation.

57. Equipment according to claim 55, wherein said duty cycle is amplitude modulated by the microprocessor (2) on the basis of the residual voltage detected in the capacitor means (3) and for providing a constant mean value throughout a time taken for the capacitor means (3) to discharge.

58. Equipment according to claim 57, wherein said microprocessor (2) is supplied with power through a voltage controller (12) which provides an electric current with a stabilized voltage.

59. Equipment according to claim 53, comprising LED diodes (7, 8) for indicating the operation of the nozzle.

60. Equipment according to claim 53, comprising electric heating means.

61. Equipment according to claim 60, wherein said electric heating means are associated with a thermostatic device.

62. Equipment according to claim 60, wherein said thermostatic device is formed by means of said microprocessor (2).

63. Equipment according to claim 60, wherein said microprocessor (2) comprises an input voltage measurement circuit (11A, 11B) for detecting the presence of voltage upstream of the voltage limiter means (10).

64. Equipment according to claim 60, wherein said electric heating means comprise the electromagnetic coils (17, 18) of said solenoid valves (5, 6).

65. Power supply equipment (1) for a fuel dispensing nozzle comprising solenoid valves (5, 6) provided with electromagnetic operating coils (17, 18), said solenoid valves (5, 6) being capable of dispensing fuel, a microprocessor (2) for operating the solenoid valves (5, 6), and electric heating means.

66. Equipment according to claim 65, wherein said electric heating means comprise the electromagnetic coils (17, 18) of said solenoid valves (5, 6).
